(19) United States
(12) Patent Application Publication
(10) Pub. No.: US 2026/0243869 A1
(43) Pub. Date: Aug. 20, 2026

(54) LiDAR SYSTEM FOR VEHICLE

(71) Applicant: Stanley Electric Co., Ltd., Tokyo (JP)

(72) Inventor: Shinya KOGURE, Tokyo (JP)

(21) Appl. No.: 19/489,543

(22) PCT Filed: May 29, 2024
(86) PCT No.: PCT/JP2024/019775

§ 371 Date: Dec. 2, 2025

(30) Foreign Application Priority Data
Jun. 20, 2023 (JP) 2023-100909

(51) Int. Cl. G01S 7/481; G01S 13/931

(52) U.S. Cl. CPC G01S 7/481; G01S 13/931; G01S 2013/93277

(57) ABSTRACT

Provided is a LIDAR system for a vehicle capable of optimizing the light distribution of laser light to be irradiated to an irradiation range while simplifying the structure of an irradiation-side optical system. A lens of an irradiation device of a LIDAR system has a reflective surface as a conical side surface, where a vertex thereof is located on the side of a light source and the central axis (auxiliary line) thereof is deviated from the optical axis (auxiliary line) of the light source, to reflect laser light from the light source radially on the reflective surface.

This application is a U.S. National Stage Application under 35 U.S. C § 371 of International Patent Application No. PCT/JP2024/019775 filed May 29, 2024, which claims the benefit of priority under 35 U.S.C. § 119 to Japanese Patent Application No. 2023-100909 filed Jun. 20, 2023, the disclosures of all of which are hereby incorporated by reference in their entireties.

### TECHNICAL FIELD

The present invention relates to a LiDAR system for a vehicle.

### BACKGROUND ART

A LiDAR system installed in a vehicle to detect a pedestrian, a leading car, or an oncoming car in front of the vehicle is known.

A LiDAR system for a vehicle in Patent Literature 1 includes an optical aperture, an emitter array equipped with emitter elements arranged and configured to output optical signals through respective sub-regions of the optical aperture in order to illuminate respective portions of a field of view, and an optical element arranged in at least part of an optical path of the optical signals (a specific optical path). For example, the optical element is configured by a diffuser, a diffractive optical element, or a lens to divert a corresponding irradiation range of an optical path corresponding to a second subset of optical signals without substantially altering the second subset of optical signals (a set of optical signals corresponding to the specific optical path).

### CITATION LIST

### Patent Literature

Patent Literature 1: PCT Japanese Translation Patent Publication No. 2022-532936

### SUMMARY OF INVENTION

### Technical Problem

In the LiDAR system for a vehicle, it is preferable that the intensity of a light distribution pattern of an irradiation range generated in front of the vehicle by irradiating laser light from an irradiation device be made different depending on the elevation angle (angle in the vertical direction) and the azimuth angle (angle in the vehicle width direction) in order to reduce total light consumption.

In the LiDAR system of Patent Literature 1, a light distribution pattern in which the intensity of laser light in a desired emission direction is increased more than in other directions is generated, but the structure is complicated because a desired light distribution pattern is generated by dividing optical signals into respective subsets, providing an individual diffuser or the like in an optical path for each subset, and adjusting the overlap of irradiated areas of respective subsets across the entire irradiation range.

It is an object of the present invention is to provide a LiDAR system for a vehicle capable of optimizing the light distribution of laser light to be irradiated to an irradiation range while simplifying the structure of an irradiation-side optical system.

### Solution to Problem

A LiDAR system for a vehicle of the present invention includes
an irradiation device that emits laser light toward a predetermined irradiation range, and
a light receiving device that has a predetermined light-receiving range including, as a search range, a range overlapping the irradiation range to receive reflected light of the laser light from a target in the search range,
wherein the irradiation device includes
   a light source that emits the laser light, and
   an optical part having, as a reflective surface, at least part of a conical side surface in a circumferential direction, where a vertex of the conical side surface is located on a side of the light source and a central axis passing through the vertex is deviated from an optical axis of the light source, to reflect the laser light, emitted from the light source and incident from the vertex side, radially on the reflective surface.

Another LiDAR system for a vehicle of the present invention includes
an irradiation device that emits laser light toward a predetermined irradiation range, and
a light receiving device that has a predetermined light-receiving range including, as a search range, a range overlapping the irradiation range to receive reflected light of the laser light from a target in the search range,
wherein the irradiation device includes
   a plurality of light sources having optical axes parallel to one another to emit laser light, and
   a plurality of optical parts provided for respective light sources, each having, as a reflective surface, at least part of a conical side surface in a circumferential direction, where a vertex of the conical side surface is located on a side of a corresponding light source, to reflect the laser light, emitted from the corresponding light source and incident from the vertex side, radially on the reflective surface,
at least one of the plurality of optical parts is a first optical part whose central axis is deviated from an optical axis of the corresponding light source, and
at least another one of the plurality of optical parts is a second optical part whose central axis matches the optical axis of the corresponding light source.

### Advantageous Effect of Invention

According to the present invention, the optical part of the irradiation device has, as the reflective surface, at least part of the conical side surface in the circumferential direction, where the vertex of the conical side surface is located on the side of the light source and the central axis passing through the vertex is deviated from the optical axis of the light source, to reflect the laser light, emitted from the light source and incident from the vertex side, radially on the reflective surface. As a result, since there is no need to divide the optical path of laser light from the light source and to assign a fine optical element such as a diffuser to each division, a desired light distribution pattern can be obtained while simplifying the structure.

### BRIEF DESCRIPTION OF DRAWINGS

FIG. 1 is a diagram illustrating an irradiation range and a light-receiving range generated forward by a vehicle equipped with a LiDAR system in a front right-end portion in a side view of the vehicle.

FIG. 2 is a diagram illustrating the irradiation range and the light-receiving range generated forward by the vehicle equipped with the LiDAR system in the front right-end portion in the plane view of the vehicle.

FIG. 3 is a block diagram of the LiDAR system.

FIG. 4 is a diagram illustrating a light distribution pattern generated in the irradiation range by an irradiation device.

FIG. 5A is a perspective view when viewing the front of the irradiation device in FIG. 3 diagonally from the upper right.

FIG. 5B is a perspective view when viewing the front of the irradiation device in FIG. 3 diagonally from the upper left.

FIG. 6A is a detailed perspective view of the irradiation device including an internal structure.

FIG. 6B is an arrow view as viewed from arrow F6B in FIG. 6A.

FIG. 6C is an arrow view as viewed from arrow F6C in FIG. 6A.

FIG. 7A is a diagram illustrating optical paths of laser light in the irradiation device.

FIG. 7B is an arrow view as viewed from arrow F7C in FIG. 7A.

FIG. 7C is an arrow view as viewed from arrow F7B in FIG. 7A.

FIG. 7D is an arrow view as viewed from arrow F7D in FIG. 7A.

FIG. 8 is a diagram illustrating irradiation ranges generated by lens parts of a lens individually.

FIG. 9A is a diagram illustrating a right-side irradiation range set in surroundings including a range in front of the vehicle by emitting laser light from the irradiation device mounted on the right front side of the vehicle while the vehicle is driving on a road.

FIG. 9B is a diagram illustrating irradiation ranges set in front of the vehicle by emitting laser light from irradiation devices respectively mounted on the front right side and the front left side of the vehicle while the vehicle is driving on a road.

### DESCRIPTION OF EMBODIMENTS

Embodiments of the present invention will be described below. The present invention includes configuration forms obtained by variously changing the embodiments within the scope of design matters of those skilled in the art. Note that components common to the plural embodiments are denoted by the same reference numerals throughout the drawings.

### Irradiation Range, Light-Receiving Range, and Search Range

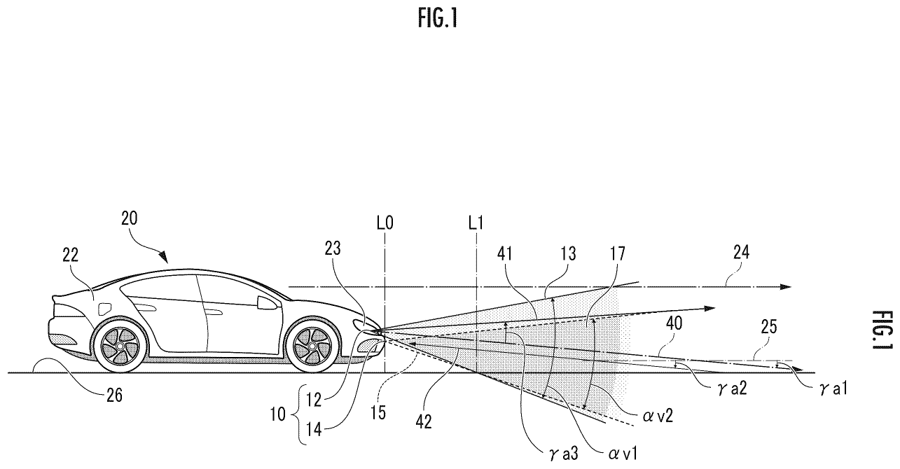

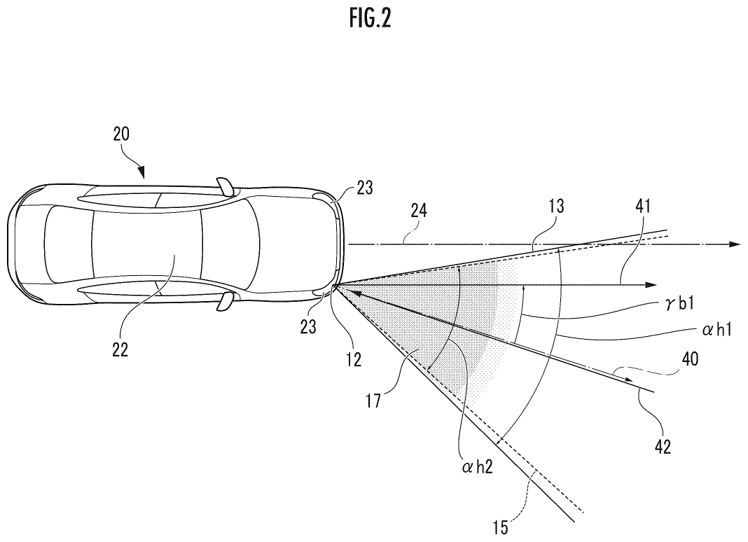

FIG. 1 and FIG. 2 are diagrams illustrating an irradiation range 13 and a light-receiving range 15 generated in front of a vehicle 20 equipped with a LiDAR system 10 on the front right-end side in a side view and a plan view of the vehicle 20, respectively. Typically, the vehicle 20 is equipped with LiDAR systems 10 both on the front left-end side and the front right-end side. This vehicle 20 is assumed to be a right-hand drive car. Although there are a flash type and a scan type in LiDAR systems, the LiDAR system 10 adopts the flash type.

A center line 24 in the front-rear direction is located in the center of the vehicle 20 in the vehicle width direction, and set at an eye level of a driver on a driver's seat in the vehicle height direction. The center line 24 in the front-rear direction extends parallel to a road surface 26, that is, horizontally in the front-rear direction of the vehicle 20.

The LiDAR system 10 includes an irradiation device 12 and a light receiving device 14. The irradiation device 12 is housed in a housing of a right headlight 23 installed on the front side of a vehicle body 22 together with an original light source of the headlight 23 (a light source that irradiates the road surface 26 with white visible light). The light receiving device 14 is installed in a position of the vehicle body 22 slightly lower than the headlight 23 in the vertical direction (up-down direction) outside the headlight 23.

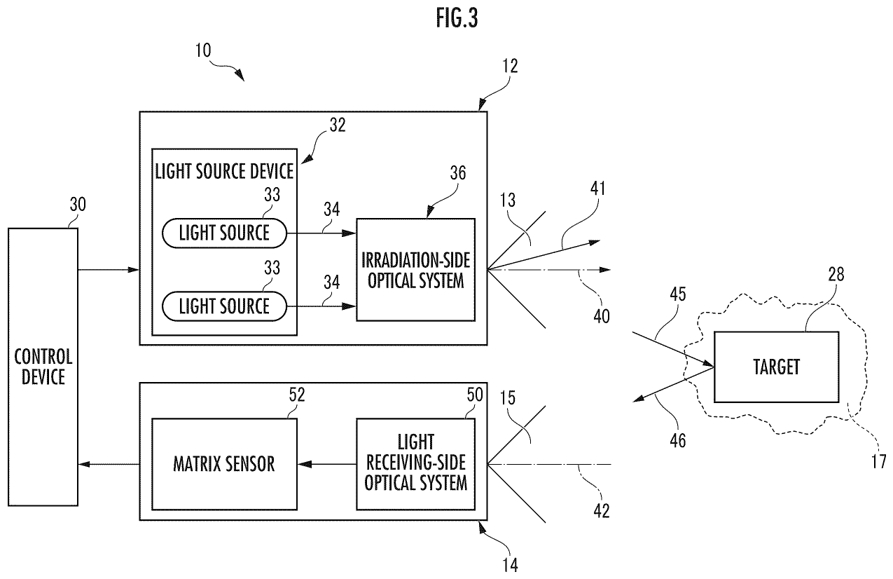

Laser light is emitted from the irradiation device 12 toward the irradiation range 13. The light receiving device 14 receives reflected light 46 (FIG. 3) returned from a target 28 (FIG. 3) to which laser irradiation light 45 (FIG. 3) emitted from the irradiation device 12 hits. The reflected light 46 that the light receiving device 14 can detect is limited to the reflected light 46 of the irradiation light 45 from the irradiation device 12. Therefore, the target 28 that can be detected by the LiDAR system 10 is limited to the target 28 existing in a search range 17 in which the irradiation range 13 and the light-receiving range 15 overlap each other.

In the irradiation range 13 of FIG. 1 and FIG. 2, an irradiation-side center optical axis 40 extends along a center line of an angle of view (also a common bisector of a vertical angle of view and a horizontal angle of view) of a FOI (Field Of Illumination) when the irradiation range 13 is viewed from the perspective of the irradiation device 12. An irradiation-side main optical axis 41 is a path of maximum intensity laser light emitted from the perspective of the FOI. A light receiving-side center optical axis 42 extends along a center line of an angle of view (also a common bisector of a vertical angle of view and a horizontal angle of view) of a FOV (Field Of View/light-receiving field of view) when the light-receiving range 15 is viewed from the perspective of the light receiving device 14.

In FIG. 1, a horizontal plane 25 is illustrated to indicate angles of inclination of the irradiation-side center optical axis 40 and the light receiving-side center optical axis 42. This horizontal plane 25 is parallel to both the center line 24 in the front-rear direction and the road surface 26, γa1 (>0) is a downward inclination angle of the irradiation-side center optical axis 40 from the horizontal plane 25. γa2 (>0) is a downward inclination angle of the light receiving-side center optical axis 42 from the horizontal plane 25. γa3 (>0) is an upward inclination angle of the irradiation-side main optical axis 41 from the irradiation-side center optical axis 40 in side view. There is a relationship of γa1<γa2. In other words, the irradiation-side center optical axis 40 is directed more upward than the light receiving-side center optical axis 42 in the side view of the vehicle 20.

γa3−γa1>0. In other words, when viewed forward from the vehicle 20, the irradiation-side main optical axis 41 is directed more upward than the horizontal plane 25. Although the irradiation device 12 is arranged in the vehicle 20 on a side vertically lower than the center line 24 in the front-rear direction, the irradiation-side main optical axis 41 gradually rises as it goes forward from the vehicle 20 and is getting closer to the center line 24 in the front-rear direction.

αv1 is a vertical angle of view (longitudinal angle of view) of the FOI from the perspective of the irradiation device 12. αv2 is a vertical angle of view (portrait angle of view) of the FOV from the perspective of the light receiving device 14. There is a relationship of αv1>αv2. Therefore, even when γa1<γa2 (FIG. 1) and the irradiation-side center optical axis 40 is directed more upward than the light receiving-side center optical axis 42 in the side view of the vehicle 20, the downward inclination angle on the lower boundary of the irradiation range 13 is larger than the downward inclination angle on the lower boundary of the light-receiving range 15 in the side view of the vehicle 20.

L0 is a vertical auxiliary line drawn at the start point of laser light emitted from the irradiation device 12 to the irradiation range 13. L1 is a vertical auxiliary line drawn at a point where the light-receiving range 15 reaches the road surface 26 in front of the vehicle 20. The irradiation range 13 reaches the road surface 26 on a side before the vertical auxiliary line L1 including at least the vertical auxiliary line L1, that is, on the side of the vehicle 20. Further, the vertical auxiliary line L1 is a point that is the shortest distance to the vehicle 20 in the front-rear direction of the vehicle 20 in the search range 17 on the road surface 26. Preferably, the irradiation range 13 also reaches the road surface 26 at the vertical auxiliary line LI like the light-receiving range 15. This is because the percentage of the search range 17 inside the irradiation range 13 increases, and hence the total light consumption of the irradiation range 13 can be reduced.

In FIG. 2, the light receiving device 14 is hidden under the irradiation device 12, but the light receiving device 14 is located at almost the same position as the irradiation device 12 in the vehicle width direction. This is because the search range 17 can be made wider when both devices are located at the same position.

αh1 is a horizontal angle of view (lateral angle of view) of the FOI. αh2 is a horizontal angle of view (lateral angle of view) of the FOV. Although αh1=αh2, there is a relationship of αh1>αh2. This is because the light receiving device 14 is more expensive than the irradiation device 12, and expanding the search range 17 by increasing the FOI is more advantageous in terms of cost than by increasing the FOV.

γb1 (>0) is an inclination angle of the irradiation-side main optical axis 41 from the irradiation-side center optical axis 40 toward the side of the center line 24 in the front-rear direction in plan view. The irradiation-side center optical axis 40 is directed outward in the vehicle width direction as viewed from the vehicle 20, whereas the irradiation-side main optical axis 41 is directed inward to approach the center line 24 in the front-rear direction. Since the intensity of laser light emitted from the irradiation device 12 to the irradiation range 13 varies depending on the direction in plan view, the distance boundary line of the irradiation range 13 is such that the direction of the irradiation-side main optical axis 41 becomes the maximum distance.

### LiDAR System

FIG. 3 is a block diagram of the LiDAR system 10. The LiDAR system 10 is controlled by a control device 30 outside the LiDAR system 10. The control device 30 is installed in the vehicle 20 separately from the LiDAR system 10. This control device 30 is a comprehensive control device capable of performing not only control of the LiDAR system 10 but also control of other electronic devices (not illustrated) installed in the vehicle 20 (for example, ADB (Adaptive Driving Beam), AFS (Adaptive Front-Lighting System), or air conditioning temperature control) together.

The irradiation device 12 includes a light source device 32 and an irradiation-side optical system 36. The light source device 32 further has at least one (two in the illustrated example) light source 33. Since this LiDAR system 10 is a flash-type LiDAR system, the control device 30 causes plural light sources 33 to simultaneously emit light in predetermined cycles. Each of the light sources 33 emits laser light toward the irradiation-side optical system 36. The optical axes 34 of the plural light sources 33 are parallel to one another.

The irradiation-side optical system 36 includes a mounting component for an optical device in addition to the optical device. The irradiation-side optical system 36 emits incident laser light from the light source device 32 to the irradiation range 13 with a predetermined intensity distribution (which is also a predetermined light distribution pattern). As the intensity of laser light is higher, the laser light can reach a distant target 28 as the irradiation light 45, and reflected light 46 with an intensity equal to or higher than a predetermined value can be returned from the target 28 to the LiDAR system 10.

The light receiving device 14 includes a light receiving-side optical system 50 and a sensor 52. The sensor 52 has plural sensor elements arranged in a grid pattern. The light receiving-side optical system 50 causes the reflected light 46 received from the search range 17 to be incident on a sensor element of the sensor 52 corresponding to the incident direction of the reflected light 46. The control device 30 detects the incident direction of each reflected light 46 based on which sensor element of the sensor 52 the reflected light 46 is incident on.

Further, the control device 30 measures the distance to the target 28 according to the TOF (Time of Flight) based on a difference between the flash lighting time of the light sources 33 and the light receiving time of the reflection light 46 received at each sensor element of the sensor 52 in the light receiving device 14. Thus, the control device 30 detects the position of each target 28 based on the incident direction of each reflected light 46 and the distance to the target 28 as the reflection source of the reflected light 46.

Further, the intensity of the reflected light 46 is related to the reflectivity of the target 28 in addition to the distance from the LiDAR system 10 to the target 28. Then, the reflectivity of the target 28 is related to the type of target 28. For example, as the type of target 28, there is a lane marking (for example, a white line) that separates a driving lane of the vehicle 20 on the road surface 26, and the location of the lane marking on the road surface 26 can be searched for from the reflectivity.

### Light Distribution Pattern

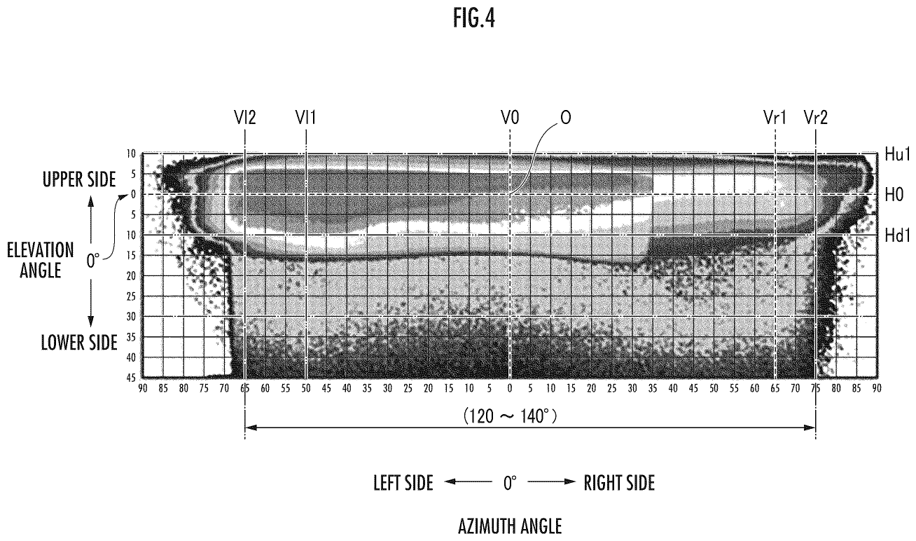

FIG. 4 is a diagram illustrating a light distribution pattern generated in the irradiation range 13 by the irradiation device 12. The light distribution pattern of FIG. 4 is assumed to be generated by the LiDAR system 10 arranged on the front right-end side of the vehicle 20 as illustrated in FIG. 2. Further, this light distribution pattern is generated on a virtual screen that is erected facing the vehicle 20 at a predetermined distant place ahead of the vehicle 20.

In FIG. 4, a color light distribution pattern is converted into a monochrome gray scale and displayed. In the color light distribution pattern, the intensity of the laser light changes from high to low and from red (warm color) to blue (cold color). Therefore, in the gray scale of FIG. 4, maximum-intensity red is displayed blackish in a manner similar to minimum-intensity ultramarine, and yellow in the middle is displayed whitish. In other words, shading does not necessarily correspond to the intensity of illumination.

In FIG. 4, the horizontal axis represents the azimuth angle and the vertical axis represents the elevation angle. In other words, the lengths of the virtual screen in the horizontal direction and the vertical direction are converted into an azimuth angle (an angle in the left-right direction) and an elevation angle (an angle in the up-down direction) from the LiDAR system 10 installed in the vehicle 20. The origin O (azimuth angle=0° and elevation angle=0°) means a direction parallel to the center line 24 in the front-rear direction.

Auxiliary lines VO and HO intersect at the origin O in FIG. 4. The left side and the right side of the auxiliary line VO correspond to the left side (1: left) and the right side (r: right) in the vehicle width direction. The upper side and the lower side of the auxiliary line HO correspond to the upper side (u: up) and the lower side (d: down) of a horizontal plane passing through the center line 24 in the front-rear direction.

In FIG. 4, in addition to the auxiliary lines VO and HO, plural auxiliary lines V12, V11, Vr1, Vr2, Hd1, and Hul are illustrated, and angular intervals between auxiliary lines are represented. The irradiation range 13 occupies a range of 20°on the upper side to 20° on the lower side in elevation angle and a range of 65 ° on the left side to 75 ° on the right side in azimuth angle. Note that the azimuth range of the irradiation range 13 is generally a range of 120° to 140°.

### Lens

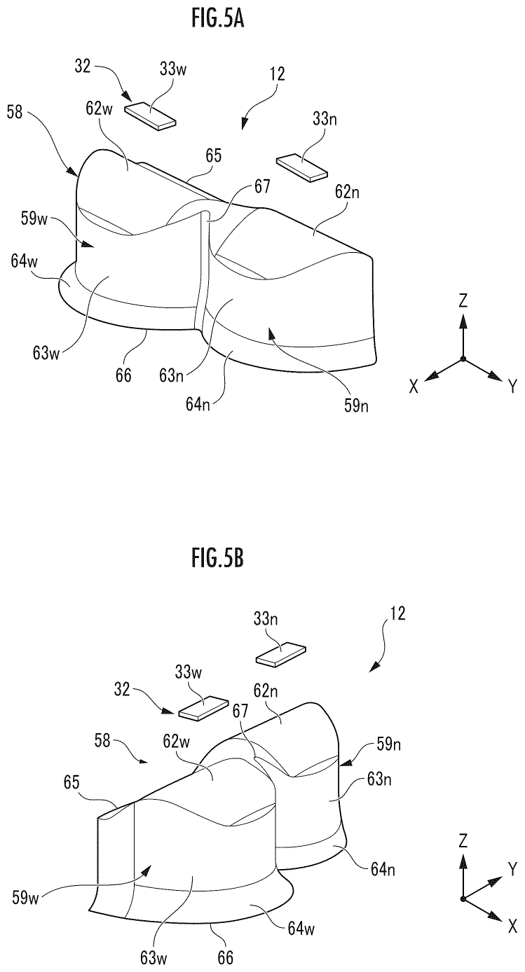

FIG. 5A and FIG. 5B are perspective views of the front of the irradiation device 12 in FIG. 3 as viewed from the upper right and the upper left, respectively. Note that the side of the light source device 32 and the opposite side of a lens 58 that constructs the irradiation-side optical system 36 in FIG. 3 are referred to as an upper side (or one end side) and a lower side (or the other end side), respectively. In a state where the LiDAR system 10 is installed in the vehicle 20, the upper side and the lower side in FIG. 3 are the upper side and the lower side of the LiDAR system 10 in the installed state.

The irradiation device 12 is equipped with optical elements for narrow light distribution and optical elements for wide light distribution separately. In FIG. 5A, elements with n (n: narrow) attached to reference numbers indicate optical elements for narrow light distribution, and elements with w (w: wide) attached to reference numbers indicate optical elements for wide light distribution.

For convenience of description, a three-dimensional coordinate system is illustrated. In FIG. 5A, X axis extends in the front-rear direction in which the front and rear of the irradiation device 12 are referred to as the front side and the rear side, respectively, and the front side is positive. Y axis extends in the left-right direction in which the right side is positive in the front view of the irradiation device 12. Z axis extends in the up-down direction in which the up side is positive in the front view of the irradiation device 12.

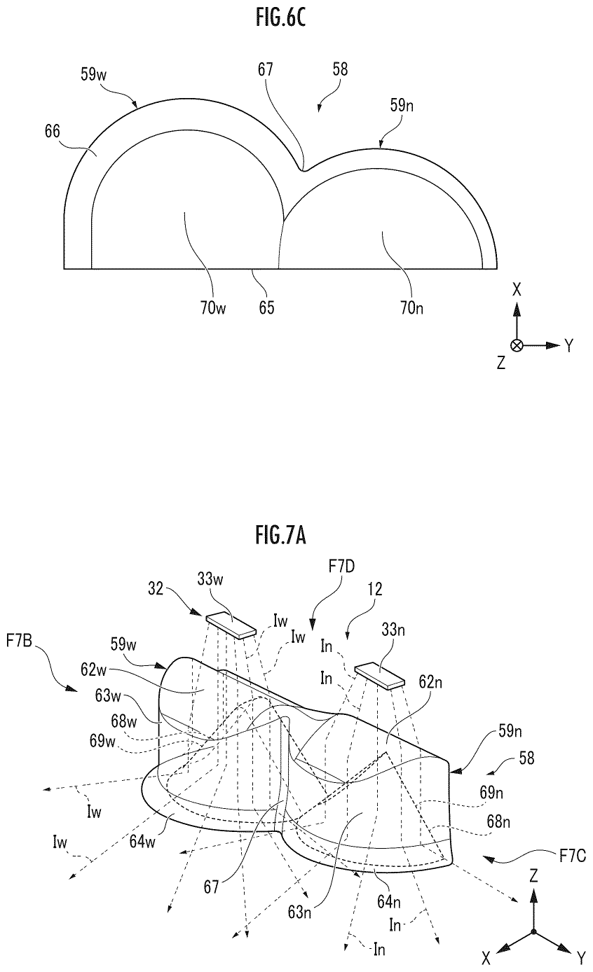

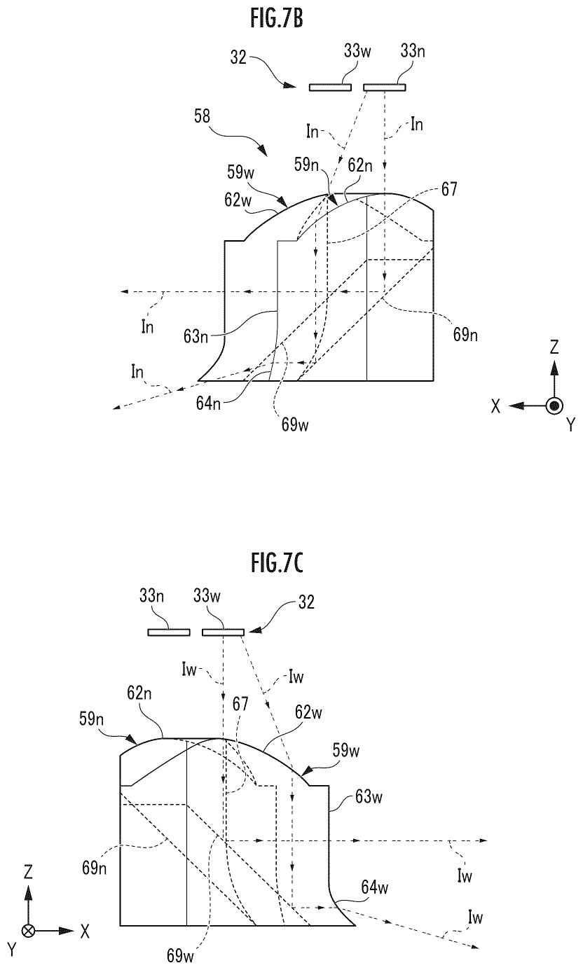

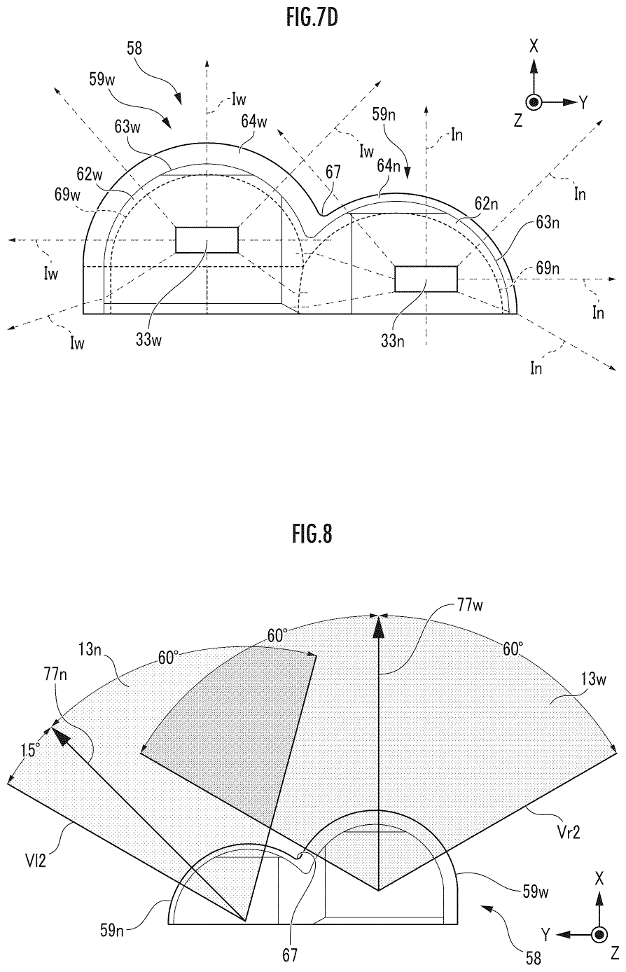

The light source device 32 is equipped with light sources 33n and 33w away from each other in the left-right direction, separately. The light source 33w is located on the left side in the left-right direction relative to the light source 33n in front view. As can be seen from FIG. 7D to be described later, the leading edge of the light source 33n is located slightly behind the leading edge of the light source 33w. The light sources 33n and 33w have optical axes extending in the up-down direction to emit laser light toward lens parts 59n and 59w as corresponding optical elements, respectively.

The single lens 58 integrally has the lens parts 59n and 59w in the left-right direction. A rear surface 65 and a bottom surface 66 of the lens 58 are common to the lens parts 59n and 59w, and both are formed as flat surfaces. A substrate (not illustrated) is mounted on the rear surface 65. The lens parts 59n and 59w have an almost identical configuration except for part of the configuration.

As for the identical configuration of the lens parts 59n and 59w, only the lens part 59n will be described and the description of the lens part 59w will be omitted. As identical components in the lens part 59n, the lens part 59n has an incident surface 62n, an emission surface 63n, and an inclined overhang portion 64n in order from top to bottom. The incident surface 62n is formed in the circumferential direction as part of a cylindrical side surface having a central axis parallel to Y axis to face an emission surface of the light source 33n in the up-down direction. The emission surface 63n is formed as part of a cylindrical side surface having a central axis extending in the up-down direction. The inclined overhang portion 64n is overhanging obliquely downward in the radial direction from a bottom edge of the emission surface 63n.

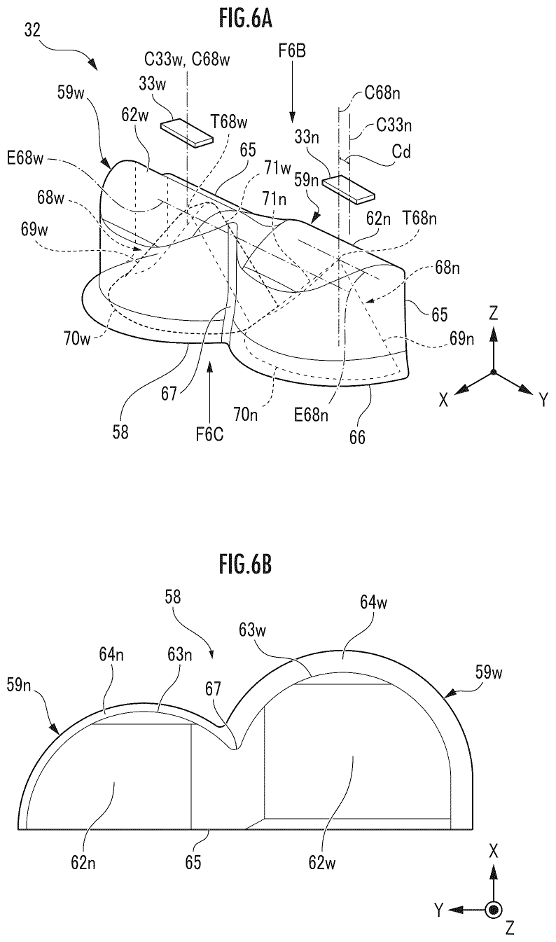

FIG. 6A is a detailed perspective view of the irradiation device 12 including the internal structure thereof. FIG. 6B and FIG. 6C are arrow views as viewed from arrows FIG. 6B and FIG. 6C in FIG. 6A, respectively.

In FIG. 6A, a conical hole 68n, the central axis of which is the central axis of the cylindrical side surface of the emission surface 63n, is formed inside the incident surface 62n. T68n is the vertex of the conical hole 68n. C33n is an auxiliary line in the up-down direction to overlap the optical axis of the light source 33n. E68n is an auxiliary line in the left-right direction to pass through the vertex T68n. C68n is an auxiliary line in the up-down direction to pass through the vertex T68n.

A reflective surface 69n is formed from at least part of a conical side surface of the conical hole 68n in the circumferential direction. The vertex angle of the conical hole 68n is, for example, 90°.

Differences between the lens parts 59n and 59w will be described. A vertex T68w is located more upward than the vertex T68n in the up-down direction. Therefore, the height of the conical hole 68w from the bottom surface 66 is higher than that of the conical hole 68. Further, the vertex T68w is located more frontward than the vertex T68n in the front-rear direction. Therefore, the radius of the bottom surface of the lens part 59w is larger than that of the lens part 59n. As a result, the light distribution angle range (azimuth angle range) of the reflective surface 69w is larger than the light distribution angle range of the reflective surface 69n, that is, the lens part 59w can generate a light distribution pattern wider than that of the lens part 59n.

It should be noted that the auxiliary line C33n is deviated more to the right than the auxiliary line C68n in the left-right direction in front view. This means that the amount of laser light emitted from the right half portion of the reflective surface 69n is larger than that emitted from the left half portion in front view. In contrast, on the reflective surface 69w, since an auxiliary line C33w and an auxiliary line C68w are at the same position, the amount of laser light emitted from the reflective surface 69w in the radial direction is evenly distributed to the left and the right.

In FIG. 6B and FIG. 6C, the conical holes 68n and 68w are open in the rear surface 65. The conical holes 68n and 68w are open as bottom openings 70n and 70w of the bottom surface 66, respectively. The radius of the bottom opening 70w is larger than the radius of the bottom opening 70n (FIG. 6C). Further, the overhang width of the inclined overhang portion 64w is larger than the overhang width of the inclined overhang portion 64n (FIG. 6B).

### Optical Paths of Irradiation Light

FIG. 7A illustrates optical paths of laser light in the irradiation device 12. FIG. 7B, FIG. 7C, and FIG. 7D are arrow views as viewed from arrows F7C, F7B, and F7D in FIG. 7A, respectively. Laser beams In and Iw mean laser beams emitted from the light sources 33n and 33w, respectively. The laser beams In and Iw are both infrared rays. In the drawings, although plural laser beams In and Iw are extending from different points of the light sources 33n and 33w as the sources of laser light, respectively, this is for the convenience of making the description easier to understand, and laser light is originally emitted from one point at the center of the optical axis (exist axis) of each of the light sources 33n and 33w and just spread out like an open fan.

The effect of the lens part 59w for wide light distribution will be described first. As for the effect of the lens part 59n, only a difference from the lens part 59w will be described. Note that the em Iw are emitted from the light source 33w and are incident on the incident surface 62w while slightly spreading. The incident surface 62w on the cylindrical side has a role as a collimator lens. Therefore, after the laser beams Iw are incident on the incident surface 62w, the laser beams Iw descend parallel to the up-down direction and hit the reflective surface 69w.

The laser beams Iw are totally reflected on the reflective surface 69w and travel in respective radial directions as emission directions the angles of which are 90° to the incident directions. The laser beams Iw reflected on the reflective surface 69w are divided into an upper portion overlapping the emission surface 63w and a lower portion overlapping the inclined overhang portion 64w.

The reflected laser beams Iw in the upper portion pass straight through the emission surface 63w and travel in respective radial directions as they are. On the other hand, the reflected laser beams Iw in the lower portion are refracted by the inclined overhang portion 64w, and travel in diagonally downward radial directions by changing the orientations to diagonally downward.

The laser beams Iw in the upper portion are emitted with equal intensity in a radial direction around Z axis. This laser light Iw corresponds to emitted light in a range of elevation angles of 10° on the upper side to 15° on the lower side in the light distribution pattern of FIG. 4. At this time, the emission surface 63w on the cylindrical side plays the role of the collimator lens so that each laser beam Iw emitted from the emission surface 63w in each radial direction travels while being prevented from spreading.

Each of the laser beams Iw in the lower portion is refracted as it passes through the inclined overhang portion 64w, and travels diagonally downward after the refraction. This laser light Iw refracted downward corresponds to irradiated light in a range of elevation angles below 15°on the lower side in the light distribution pattern of FIG. 4. Note that laser beams Iw emitted from the emission surface 63w and laser beams Iw emitted from the inclined overhang portion 64w may be mixed together in the vicinity of the elevation angle of 15° on the lower side.

Next, as for the laser light In emitted from the light source 33n, only the difference from the laser light Iw will be described. The optical axis (auxiliary line C33n) of the light source 33n is slightly deviated to the right from the vertex T68n in the front view of the lens 37n. Therefore, although the laser light In passing through the incident surface 62n as the collimator lens descends straight in the up-down direction, the irradiation amount of the right half portion of the reflective surface 69n on the conical side is larger than that of the left half portion.

As a result, the emission intensity of the laser light In emitted in the right direction becomes higher than the emission intensity of the laser light In emitted in the left direction (to the side of the lens part 59w) on the reflective surface 69n. This corresponds to the fact that the irradiation-side main optical axis 41 is deviated from the irradiation-side center optical axis 40 toward the center line 24 in the front-rear direction in FIG. 2.

FIG. 8 illustrates irradiation ranges 13n and 13w generated by the lens parts 59n and 59w of the lens 58 individually. A main optical axis 77w in the irradiation range 13w is on the center optical axis in the irradiation range 13w, that is, on the center line of the irradiation range 13w. On the other hand, a main optical axis 77n in the irradiation range 13n is deviated from the center line of the irradiation range 13n to the opposite side of the lens part 59w. Note that auxiliary lines V12 and Vr2 in FIG. 8 correspond to the auxiliary lines V12 and Vr2 in FIG. 4.

### Set Search Range

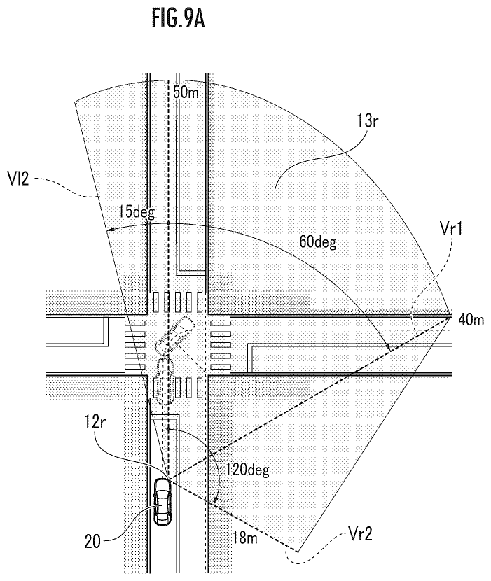

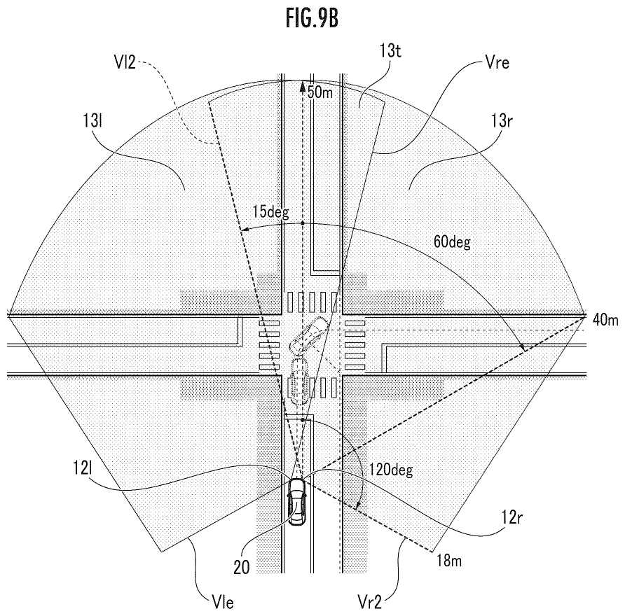

FIG. 9A illustrates a right-side irradiation range 13r set in surroundings including a range in front of the vehicle 20 by emitting laser light from an irradiation device 12r mounted on the right front side of the vehicle 20 while the vehicle 20 is driving on a road. Actually, the LiDAR system 10 is installed in the front right-end portion of the vehicle 20 and is set to generate the irradiation range 13r, that is, for example, to generate the light distribution pattern illustrated in FIG. 4.

Although auxiliary lines V12, Vr1, and Vr2 extending clockwise in the radial direction in FIG. 9A are different in azimuth angle from those in FIG. 4, the auxiliary lines are appended to indicate correspondences in terms of the intensity of laser light with the intensities of the auxiliary lines V12, Vr1, and Vr2 extending vertically in FIG. 4. In FIG. 9A, a direction straight ahead of the vehicle 20, that is, a direction 50 m ahead of the vehicle 20 where the azimuth angle is 0° and the intensity of laser light is the maximum corresponds to the auxiliary line V11 in FIG. 4.

“Numerical value +m” written in FIG. 9A indicates, in units of m (meters), a distance that laser light from an irradiation device 121 reaches with a rated intensity or more. “deg” means “°” as the unit of angle.

FIG. 9B illustrates irradiation ranges 13r and 131 set in front of the vehicle 20 by emitting laser light from irradiation devices 12r and 121 respectively mounted on the front right side and the front left side of the vehicle 20 while the vehicle 20 is driving on a road.

In FIG. 9B, auxiliary lines Vle and Vre are left and right boundaries of an irradiation range 131, respectively, and correspond to auxiliary lines Vr2 and V12 of an irradiation range 13r. A fan-shaped range of the auxiliary lines V12 and Vre as a circumferential angle is a range in which the irradiation ranges 131 and 13r overlap each other.

### Variations and Supplementary Notes

In the LiDAR system 10 of the embodiments, the flash method is adopted, but the irradiation method in the LiDAR system for a vehicle of the present invention is not limited to the flash method, and the irradiation method may also be the scan method or any other method.

In the LiDAR system 10, each of the emission surfaces 63n and 63w is formed as part of the conical side surface in the circumferential direction, respectively. However, in a case where the LiDAR system 10 is mounted on a roof of a vehicle or the like, emission surfaces can also be formed as conical side surfaces around the circumference as a whole to emit laser light radially outward across the entire 360-degree circumference.

In the LiDAR system 10, the lens 58 has two lens parts of the lens parts 59n and 59w respectively as a first optical part and a second optical part of the present invention. In the present invention, however, only one lens part 59n can be provided as an optical element, or three or more lens parts 59n, 59w can be provided in total. In this case, like the lens part 59n, at least one lens part is assumed to be an optical element that causes the optical axis of the light source 33n and the central axis of the reflective surface 69n to deviate from each other. Further, when the LiDAR system 10 includes plural lens parts 59w in the left-right direction in front view, the heights of the vertexes T69 of the reflective surfaces 69 in respective lens parts 59w can be made different from one another to make individual light distribution ranges different from one another and to adjust a mutual overlap range between adjacent ones of the plural light distribution ranges.

The inclined overhang portion 64n, 64w of the LiDAR system 10 corresponds to a refractive emission portion of the present invention. The refractive emission portion of the present invention is not limited to the inclined overhang portion. As long as it is formed on the lower side of the emission surface 63n, 63w as the side surface of the lens 58 (using the up-down direction defined in the description of FIG. 5A), that is, it is formed on a curved side surface to refract laser light, reflected from the lower end portion of the reflective surface 69n, 69w, diagonally downward and outward in the radial direction, there is no need to limit the formed surface to the surface of the inclined overhang portion 64n, 64w.

The irradiation device 12 may be incorporated in the housing of the headlight 23 in the first place. In this case, the manufacturer of the vehicle 20 can install the LiDAR system 10 during manufacturing of the vehicle 20 by preparing the light receiving device 14 and the headlight 23 with the built-in irradiation device 12 separately, not as one set.

In this LiDAR system 10, the emission surface 63n, 63w is formed on the conical side coaxial with the conical side of the reflective surface 69n, 69w. As a result, the emission surface 63n, 63w can serve as the collimator lens for laser light emitted from the emission surface 63n, 63w in the radial direction. It is also possible that the emission surface 63n, 63w is made to be a curved surface other than the conical side surface to make the light distribution to each radial direction uneven.

### DESCRIPTION OF REFERENCE NUMERALS

10 . . . LiDAR system, 12 . . . irradiation device, 13 . . . irradiation range, 14 . . . light receiving device, 15 . . . light-receiving range, 17 . . . search range, 20 . . . vehicle, 23 . . . headlight, 26 . . . road surface, 28 . . . target, 30 . . . light source device, 33 . . . light source, 36 . . . irradiation-side optical system, 40 . . . irradiation-side center optical axis, 41 . . . irradiation-side main optical axis, 42 . . . light receiving-side center optical axis, 45 . . . irradiation light, 46 . . . reflected light, 50 . . . light receiving-side optical system, 58 . . . lens, 62 . . . incident surface, 63 . . . emission surface, 64 . . . inclined overhang portion, 66 . . . bottom surface, 69 . . . reflective surface, 70 . . . bottom opening.

1. A LiDAR system for a vehicle comprising:
an irradiation device that emits laser light toward a predetermined irradiation range; and
a light receiving device that has a predetermined light-receiving range including, as a search range, a range overlapping the irradiation range to receive reflected light of the laser light from a target in the search range,
wherein the irradiation device includes
a light source that emits the laser light, and
an optical part having, as a reflective surface, at least part of a conical side surface in a circumferential direction, where a vertex of the conical side surface is located on a side of the light source and a central axis passing through the vertex is deviated from an optical axis of the light source, to reflect the laser light, emitted from the light source and incident from the vertex side, radially on the reflective surface.

2. The LiDAR system for a vehicle according to claim 1, wherein
the optical part has a lens in which the conical side surface is formed and a conical cavity with a bottom surface open on another end side opposite to one end side as the side of the light source is formed, and
the lens has
an incident surface formed on the one end side as a lens surface of a collimator lens and on which laser light from the light source is incident, and
an emission surface formed on a side surface to cover the conical side surface from outside in the radial direction to emit the laser light reflected on the reflective surface outward in the radial direction.

3. The LiDAR system for a vehicle according to claim 2, wherein the lens further has a refractive emission portion formed on the side surface more on the other end side than the emission surface to refract the laser light, reflected in the radial direction from an edge portion on the other end side of the reflective surface, diagonally to the other end side and to emit the laser light.

4. A LiDAR system for a vehicle comprising:
an irradiation device that emits laser light toward a predetermined irradiation range; and
a light receiving device that has a predetermined light-receiving range including, as a search range, a range overlapping the irradiation range to receive reflected light of the laser light from a target in the search range,
wherein the irradiation device includes
a plurality of light sources having optical axes parallel to one another to emit laser light, and
a plurality of optical parts provided for respective light sources, each having, as a reflective surface, at least part of a conical side surface in a circumferential direction, where a vertex of the conical side surface is located on a side of a corresponding light source, to reflect the laser light, emitted from the corresponding light source and incident from the vertex side, radially on the reflective surface,
at least one of the plurality of optical parts is a first optical part whose central axis is deviated from an optical axis of the corresponding light source, and
at least another one of the plurality of optical parts is a second optical part whose central axis matches the optical axis of the corresponding light source.

5. The LiDAR system for a vehicle according to claim 4, wherein
the plurality of optical parts are formed inside a single lens,
in each optical part, the conical side surface is formed, and a conical cavity with a bottom surface open on another end side opposite to one end side as the side of the light source is formed, and
each optical part has
an incident surface formed on the one end side as a lens surface of a collimator lens and on which laser light from the light source is incident, and
an emission surface formed on a side surface to cover the conical side surface from outside in the radial direction to emit the laser light reflected on the reflective surface outward in the radial direction.

6. The LiDAR system for a vehicle according to claim 5, wherein each optical part further has a refractive emission portion formed on the side surface more on the other end side than the emission surface to refract the laser light, reflected in the radial direction from an edge portion on the other end side of the reflective surface, diagonally to the other end side and to emit the laser light.

7. The LiDAR system for a vehicle according to claim 3, wherein the LiDAR system is installed in a front portion of a vehicle and an end portion of the vehicle in a vehicle width direction.

8. The LiDAR system for a vehicle according to claim 7, wherein the irradiation device is arranged inside a housing of a headlight, and the light receiving device is arranged outside of the housing.

9. The LiDAR system for a vehicle according to claim 4, wherein
the LiDAR system is installed in a front portion of a vehicle and an end portion of the vehicle in a vehicle width direction, and
the first optical part and the second optical part are located inside and outside in the vehicle width direction.

10. The LiDAR system for a vehicle according to claim 4, wherein the LiDAR system is installed in a front portion of a vehicle and an end portion of the vehicle in a vehicle width direction.

11. The LiDAR system for a vehicle according to claim 10, wherein the irradiation device is arranged inside a housing of a headlight, and the light receiving device is arranged outside of the housing.
